(19) United States
(12) Patent Application Publication
(10) Pub. No.: US 2004/0096307 A1
(43) Pub. Date: May 20, 2004

(54) Bale handling apparatus

(76) Inventor: Coy C. McGinnes, Canton, TX (US)

Correspondence Address: INNOVAR, LLC, P O BOX 250647, PLANO, TX, 75025, US

(21) Appl. No.: 10/294,085

(22) Filed: Nov. 14, 2002

(51) Int. Cl. B66C 1/00

(52) U.S. Cl. 414/722

(57) ABSTRACT

The invention provides a bale handling apparatus capable of being used to lift and transport two similar bales in a substantially side-by-side manner. The apparatus includes at least two vertically and horizontally offset main spears. Each main spear is grouped with at least one vertically and/or horizontally offset stabilizer spear. By virtue of the offset design of the main spears, the apparatus can be used to lift two bales sequentially by lifting a first bale and then lifting a second bale without unloading the first bale from the apparatus. The two bales can then be transported simultaneously to another location.

### FIELD OF THE INVENTION

The present invention concerns a bale handling apparatus capable of lifting and transporting two bales. More particularly, the invention concerns a hay bale lifting and transport apparatus comprising horizontally offset spears to facilitate the lifting of a second bale while a first bale is being carried by the apparatus.

### BACKGROUND OF THE INVENTION

A number of U.S. Patents disclose hay bale transport devices. U.S. Pat. No. 4,120,405 to Jones et al. discloses a hay bale pickup device that has one main spear and two stabilizer spears. This device can lift and carry only one bale at a time.

U.S. Pat. No. 5,129,775 to Coats et al. discloses a hay bale-handling device including one main spear and four stabilizer spears. The vertical height of the device is hydraulically adjustable. This device can lift and carry only one bale at a time.

U.S. Pat. No. 4,527,935 to Fortenberry discloses a trailer-type hay bale transport device including one centrally mounted main spear and two laterally mounted stabilizer spears. The stabilizer spears are longer than the main spear, and this device can lift only one bale at a time.

U.S. Pat. No. 4,674,786 to Lynch discloses a hay bale transport device having one main spear and two stabilizer spears. This patent also discloses the use of a reinforcing tubular brace that surrounds the main spear to add strength to the spear. This device can lift and transport only one bale at a time.

U.S. Pat. No. 4,249,842 to Johnson discloses a hay bale transport trailer having a hay bale loading device attached to it. The trailer can transport more than one bale; however, the loading device can only lift one bale at a time. The loading device has one main spear and two stabilizer spears.

U.S. Pat. No. 4,306,825 to Yilit discloses a hay bale handling device for use on a three-point tractor hitch. The device can lift and transport two bales at a time. The device includes two spear assemblies, each assembly comprising a main spear and a stabilizer spear. The main spear and stabilizer spear in an assembly are in fixed relation to one another, meaning that they do not move with respect to one another. However, each assembly moves independently of the other, since each assembly is hydraulically operated. During operation, a first assembly is used to impale and lift a first bale. Then a second bale is impaled and lifted with the second assembly. The main spears are pivotally mounted onto the frame and their pitch is adjustable by way of the hydraulic mechanism. The proximal base of the main spears is not vertically offset from one another. This type of apparatus is disadvantageous since it requires more maintenance and is subject to breakdown due to the use of hydraulics to adjust the pitch of the spears.

Thus, none of the known art discloses a hay bale handling device capable of picking up two bales of hay and carrying them in tandem. Due to the need to improve farming efficiency while reducing labor costs, a need remains for improved hay bale handling equipment.

### SUMMARY OF THE INVENTION

The present invention seeks to overcome some or all of the disadvantages inherent in the art. The present invention provides a low maintenance bale handling apparatus having at least two vertically and horizontally offset impaling spears and at least two stabilizer spears and being capable of lifting and carrying at least two bales. The apparatus is adapted for use with a tractor, and a specific embodiment is adapted for mounting onto a three-point hitch of a tractor. The apparatus is used as follows. The first main spear has a higher vertical offset, relative to the ground or the base of the apparatus, than the second main spear. The apparatus is mounted onto a tractor, for example, and its vertical height relative to the ground is adjusted such that the first main spear is directed at a first bale. The tractor is then moved toward a first bale such that the first main spear and a corresponding first stabilizer spear, substantially to their hilts, impale the first bale. The first bale is then lifted a first height and the second main spear is directed at a second bale. The tractor is then moved toward the second bale such that the second main spear and a corresponding second stabilizer spear, substantially to their hilts, impale the second bale. The second bale is then lifted off the ground and the first and second bales are ready for simultaneous transport to a desired location. The bales are then unloaded in reverse order by placing the second bale down and moving the tractor to remove the second main spear and stabilizer spear from the second bale. The apparatus is lowered further until the first bale contacts the ground. The tractor is then moved to remove the first main spear and stabilizer spear from the first bale. The above is accomplished without the use of hydraulic mechanisms to adjust the vertical pitch of the main spears relative to one another.

The apparatus can be adapted for mounting onto the rear or front of a tractor. A specific embodiment is adapted for mounting onto the rear three-point hitch of a tractor. Another specific embodiment is adapted for mounting onto the front-end loader assembly of a tractor.

One aspect of the invention provides a bale handling apparatus comprising:

a mounting assembly;

a frame onto which the mounting assembly is attached;

a first set of spears comprising a first main spear and a spaced away first stabilizer spear; and

a second set of spears comprising a second main spear and a spaced away second stabilizer spear; wherein

the first and second sets of spears are horizontally offset from each other and are attached to the frame;

the base of the first main spear is vertically offset from the base of the second main spear, with respect to the frame; and

the main spears are longer than the stabilizer spears.

Specific embodiments of the invention include those wherein: 1) the apparatus comprises plural first main spears; 2) the apparatus comprises plural second main spears; 3) the apparatus comprises plural first stabilizer spears; 4) the apparatus comprises plural second stabilizer spears; 5) the mounting assembly is adapted for mounting the apparatus onto a three-point hitch; 6) the base of the first main spear is vertically offset from the base of the second main spear by a distance of at least 8 inches; 7) the stabilizer spear is spaced away from the main spear by a distance of at least about 4.5 ft. for a 4 ft. diameter bale or at least about 6.5 ft. for a 6 ft. diameter bale; 8) the first and second main spears are horizontally offset by a distance that is less than the average diameter of a bale that the apparatus is adapted to lift; 9) the first and second main spears are horizontally offset by a distance that is greater than the average diameter of a bale that the apparatus is adapted to lift; 10) the first and second main spears are horizontally offset by a distance that approximates the average diameter of a bale that the apparatus is adapted to lift; 11) each stabilizer spear is horizontally offset with respect to its respective main spear; 12) the mounting assembly comprises plural mounting brackets; 13) each set of spears comprises a single main spear and one or more stabilizer spears; or 14) each set of spears comprises a single stabilizer spears.

### BRIEF DESCRIPTION OF THE FIGURES

The following figures form part of the present description and describe exemplary embodiments of the claimed invention. In light of these figures and the description herein, the skilled artisan will be able to practice the invention without undue experimentation.

FIGS. 1a-1b depict a perspective view of a hay bale lifting and transport apparatus of the invention.

FIG. 2 depicts a top plan view of an alternate embodiment of the hay bale lifting and transport apparatus of FIG. 1a.

FIG. 3 depicts a front elevation view of an alternate embodiment of the hay bale lifting and transport apparatus.

FIG. 4 depicts a side elevation view of the hay bale lifting and transport apparatus of FIG. 3.

FIG. 5 depicts a side elevation view of an alternate embodiment of the hay bale lifting and transport apparatus of FIG. 3.

### DETAILED DESCRIPTION OF THE INVENTION

The bale handling apparatus of the invention comprises a strong material capable of sustaining substantial weight, torque and leverage. A preferred material is metal. Suitable metals include steel, iron, cold rolled iron, angle iron, strengthened steel, chrome-plated steel or iron. The metal can be in the form of tubing, solid rod, bracket, angled bracket or any other format that retains structural integrity while lifting heavy objects.

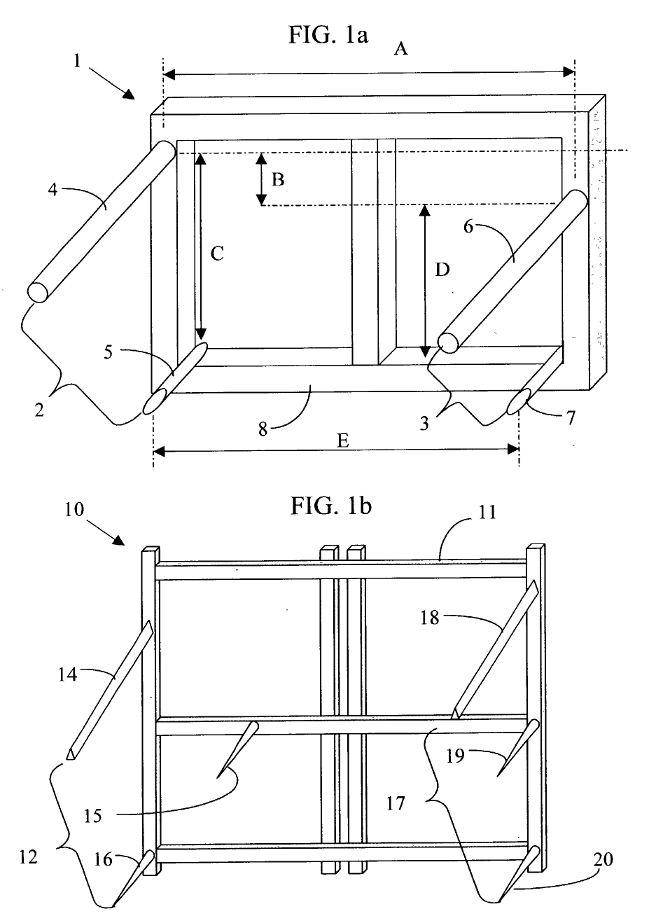

The exemplary bale handling apparatus (1) of FIG. 1 includes a first pair (2) and second pair (3) of spears. Each pair of spears comprises a main spear (4 or 6) and corresponding stabilizer spear (5, 7, respectively). The spears are attached to a frame (8), which includes a mounting assembly (not shown). The pairs (2, 3) are horizontally offset (spaced away) from each other by a distance (A). The main spears are vertically offset from each other by a distance (B). Likewise, the stabilizer spears are horizontally offset from each other by a distance (E). In this exemplary embodiment, the stabilizer spears (5, 7) are not vertically offset; therefore, the spacing (C) between the main spear (4) and the stabilizer spear (5) is different than the spacing (D) between the main spear (6) and the stabilizer spear (7).

The horizontal distance (A) between the main spears can be greater than, approximately equal to or less than the average diameter, average length or average width of a bale for which the apparatus (1) is adapted to lift. For example, if the apparatus is intended for use in lifting and transporting cylindrical bales, the distance (A) can be greater than, less than or approximately equal to the average diameter of the cylinder. The distance, however, will be sufficiently large to permit simultaneous transport of at least of the bales in side-by-side arrangement. Generally, the distance will be at least about 75%, 80%, 85%, 90% or 95% of the average diameter of the bale. In other embodiments, the distance (A) approximates (is within 95% to 105% of) the average diameter of the bale. In still other embodiments, the distance (A) is greater than (at least about 105%, 108%, 110%, 115%, or 120%, or greater than 120% of) the average diameter of the bale.

The horizontal spacing between the main spears is generally less than two diameter of the largest bale for which the apparatus is adapted to lift.

The vertical distance or offset (B) is at least about 8%, 10%, 15% or 20% of the average diameter of a bale for which the apparatus (1) is adapted to lift. By virtue of the vertical offset of the bases of the main spears, the present system does not require individually hydraulically controlled main spears such as the prior art system of Yilit (U.S. Pat. No. 4,306,825).

Accordingly, the present apparatus requires less maintenance and is more cost effective than the prior art system.

The vertical distances (C, D) between the main spears (4, 6) and the respective stabilizer spears (5, 7) is less than the average diameter of a bale which the apparatus is adapted to lift and transport. The distance (C, D) is generally from about 25% to about 85% or about 30% to about 75% or about 35% to about 65% of the average diameter of a bale which the apparatus is adapted to lift and transport.

The distance (E) between the stabilizer spear(s) of the first pair (2) and the second pair (3) can be any distance provided that the stabilizer spears remain spaced away from each other.

The bale handling and transport apparatus (10) of FIG. 1b comprises a different frame (11) and different sets (12, 17) of spears. The first set (17) comprises a main spear (18), a proximal stabilizer spear (19) and a distal stabilizer spear (20). The distance between the stabilizer spears can be as desired. The distance between the distal stabilizer spear (20) and the main spear (18) is as described above. The distance between the proximal stabilizer spear (19) and the main spear is generally at least 10% and up to about 85% of the average diameter of a bale which the apparatus is adapted to lift and transport. Although, the stabilizer spears (19-20) and the main spear (18) form an essentially straight line, the stabilizer spears (15, 16) and main spear (14) form a triangle rather than a straight line. Accordingly, placement of a stabilizer spear relative to its respective main spear can be varied as desired.

The main spear can be shaped as desired. Its length should be sufficient to penetrate at least about 75% the depth of a bale as measured in the direction in which the spear penetrates the bale. The main spear can be longer than the depth of the bale. For example, for a cylindrical bale, its depth is measured as the distance between the two flat ends of the cylinder. When the main spear penetrates the bale in a direction approximately parallel to the central axis of the cylinder, the main spear will generally be at least 70% or greater than 75% of the depth of the bale. The length of a stabilizer spear is generally at least about 25% or 30% of the depth of a bale as measured in the direction in which the spear penetrates the bale.

The cross-sectional shape of the spears can be shaped as desired. For, example, the cross-section can assume any geometric shape including a circle, oval, ellipse, trapezoid, triangle, square, parallelogram, pentagon, hexagon, figure having seven or more sides, multi-pointed star, diamond, semicircle, cross, or any other shape. The cross-section can by symmetrical or asymmetrical. The cross-sectional shape of the spears (4-7) is a circle; however, the cross-sectional shape of the spears (14, 18) is a triangle.

The cross-sectional diameter of the spears can remain constant or change throughout its length. For example, the spears (4-7) possess a constant cross-sectional diameter, where the main spear has a larger diameter than a stabilizer spear. On the other hand, the spears (14-16, 18-20) are tapered and possess a changing cross-sectional diameter. The spears (15-16, 19-20) are pointed and conical. By employing a tapered cross-sectional diameter, the spears are more easily inserted into and extracted from a bale.

The surface of the spears can be smooth, regular, irregular, rough, barbed, serrated, knurled, cross-hatched, etched, or spiral. The surface can be uncoated or coated. Coating material may serve to material protect the spear or improve its performance.

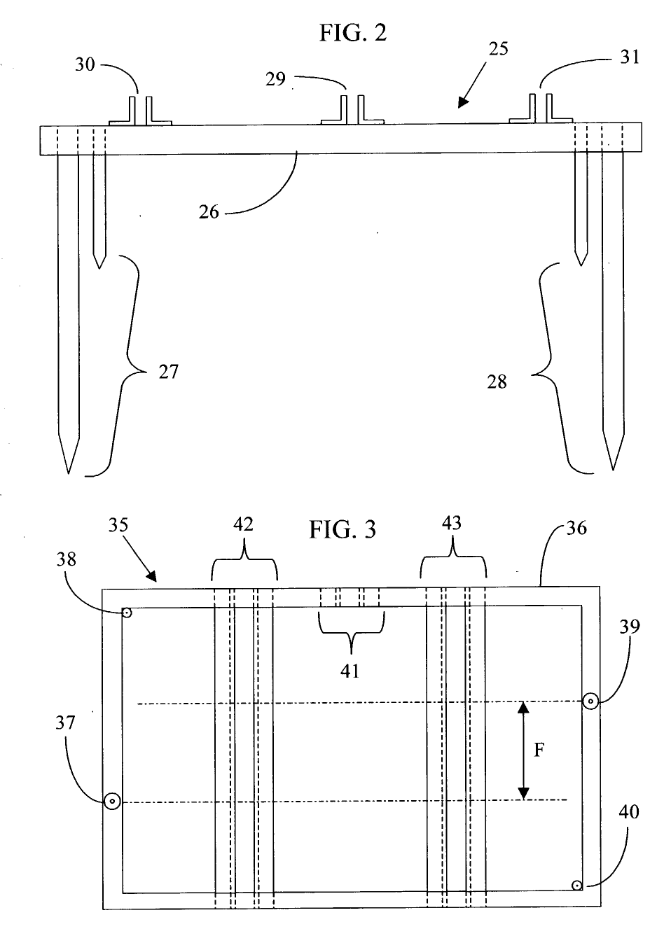

FIG. 2 depicts a top plan view of a bale handling apparatus (25) comprising a mounting assembly (29-31), frame (26), first set of spears (27) and second set of spears (28). Each main spear is vertically and horizontally offset with respect to its corresponding stabilizer spear. The mounting assembly comprising three mounting bracket assemblies (29-31). In this exemplary embodiment, the mounting assembly is adapted for mounting onto a complementary three-point hitch, such as found on a farm tractor. The mounting assembly is bolted, latched or otherwise engaged with or secured to a complementary mounting assembly of operating equipment used to operate the bale handling apparatus.

An alternate embodiment of the bale handling apparatus (35) is depicted in FIG. 3, which is a front elevation view. The apparatus (35) comprises two main spears (37, 39) and respective stabilizer spears (38, 40). The spears are pointed and substantially cylindrical. The main spears are vertically offset from each other by a distance (F). In this embodiment, the stabilizer spears are on opposite corners of the frame (36) such that the stabilizer spear (38) is above its respective main spear (37), and the stabilizer spear (40) is below its respective main spear (39). The uppermost mounting bracket assembly (41) is attached to the upper crossbar of the frame. The other mounting bracket assemblies (42, 43) are paired opposing L-shaped bars adapted to receive and engage with a complementary mounting assembly of an operating equipment.

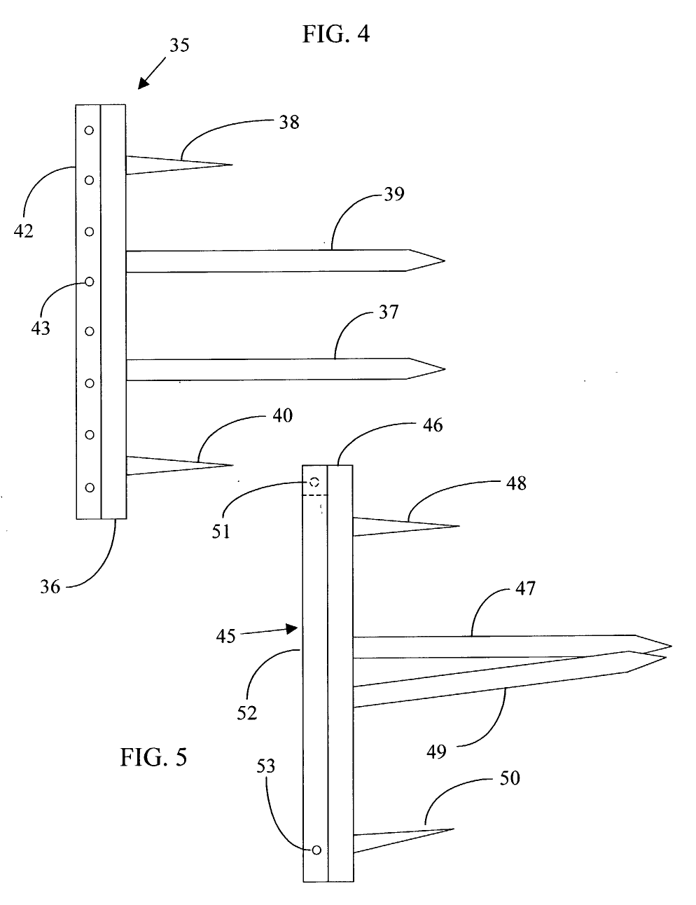

FIG. 4 depicts side view elevation of a first embodiment of the apparatus (35) of FIG. 3. The extended L-shaped bar of the mounting assembly (42) comprises one or more holes (43) by way of which the mounting assembly can be engaged with the operating equipment. The stabilizer spears (38, 40) are conical and pointed, whereas the main spears (37, 39) are cylindrical and pointed. According to FIGS. 3 and 4, the axes of the spears are substantially parallel. However, the alternate embodiment (45) depicted in FIG. 5 comprises a main spear (49) that is not vertically parallel with the main spear (47) and a stabilizer spear (50) that is not parallel with the stabilizer spear (48). However, each stabilizer spear is substantially parallel with its respective main spear. Even though the main spears (47, 49) are not parallel when viewed from the side they can still be parallel when viewed from the top or front of the apparatus. That said, each set of spears is independently parallel or nonparallel with another set of spears. It is only necessary that each of the spears point away from the front of the apparatus. The apparatus (45) comprises an extended L-shaped rod (52) including an integral mounting assembly (53). The uppermost mounting assembly (51) is depicted in ghost and is attached to the upper crossbar of the frame (46).

The frame can be shaped as desired to form a rectangle, square, triangle or other geometric form. Specific embodiments of the frame include those wherein the frame is asymmetric or symmetric.

The apparatus of the invention can be mounted on any suitable operating equipment. Specific embodiments include those wherein the apparatus is mounted on farm equipment, in particular a tractor. More specific embodiments includes those wherein the apparatus is adapted for mounting onto the front-end or rear-end of a tractor. The apparatus can be secured or attached to a front-end loader of a tractor or can be mounted in its place. The apparatus can be modified as disclosed in the above-cited U.S. patents for mounting onto the front-end or rear-end of a tractor.

As used herein, the term bale refers to a large pressed bundle of goods. Such goods include hay, cotton, grass, alfalfa, wheat, oats, cane, sorghum, and other produce, grains or grasses.

The apparatus of the invention can be tailored to lift and transport any size or shape bales. Typically, bales are round, cylindrical, square-cubic, or rectangular-cubic.

In view of the above description and the attached drawings, one of ordinary skill in the art will be able to practice the invention as claimed without undue experimentation. The foregoing will be better understood with reference to the specification that details certain procedures for the preparation of an apparatus according to the present invention. All references made to these examples are for the purposes of illustration. Examples herein should not be considered exhaustive, but merely illustrative of only a few of the many embodiments contemplated by the present invention.

The above is a detailed description of particular embodiments of the invention. It will be appreciated that, although specific embodiments of the invention have been described herein for purposes of illustration, various modifications may be made without departing from the spirit and scope of the invention. Accordingly, the invention is not limited except as by the appended claims. All of the embodiments disclosed and claimed herein can be made and executed without undue experimentation in light of the present disclosure.

What is claimed is:

1) A bale handling apparatus comprising:
a mounting assembly;
a frame onto which the mounting assembly is attached;
a first set of spears comprising a first main spear and a spaced away first stabilizer spear; and
a second set of spears comprising a second main spear and a spaced away second stabilizer spear; wherein
the first and second sets of spears are horizontally offset from each other and are attached to the frame;
the base of the first main spear is vertically offset from the base of the second main spear, with respect to the frame; and
the main spears are longer than the stabilizer spears.

2) The apparatus of claim 1, wherein the apparatus comprises plural first main spears and/or plural second main spears.

3) The apparatus of claim 2, wherein the apparatus comprises plural first stabilizer spears and/or plural second stabilizer spears.

4) The apparatus of claim 1, wherein the apparatus comprises plural first stabilizer spears and/or plural second stabilizer spears.

5) The apparatus of claim 1, wherein the mounting assembly is adapted for mounting the apparatus onto a three-point hitch.

6) The apparatus of claim 1, wherein the base of the first main spear is horizontally offset from the base of the second main spear by a distance that is less than or approximately equal to the average diameter, average length or average width of a bale which the apparatus is adapted to lift.

7) The apparatus of claim 1, wherein the base of the first main spear is horizontally offset from the base of the second main spear by a distance that is greater than the average diameter, average length or average width of a bale which the apparatus is adapted to lift.

8) The apparatus of claim 1, wherein the base of the first main spear is horizontally offset from the base of the second main spear by a distance that is at least about 75% of the average diameter, average length or average width of a bale which the apparatus is adapted to lift.

9) The apparatus of claim 1, wherein the base of the first main spear is vertically offset from The base of the second main spear by a distance that is at least about 5% of the average diameter, average length or average width of a bale which the apparatus is adapted to lift.

10) The apparatus of claim 1, wherein at least one stabilizer spear is spaced away from its respective main spear by a distance of at least about 25% to about 85% of the average diameter, average length or average width of a bale which the apparatus is adapted to lift.

11) The apparatus of claim 1, wherein at least one stabilizer spear is horizontally offset with respect to its respective main spear.

12) The apparatus of claim 1, wherein the mounting assembly comprises plural mounting brackets.

13) The apparatus of claim 1, wherein each set of spears comprises a single main spear and one or more stabilizer spears.

14) The apparatus of claim 13, wherein each set of spears comprises a single stabilizer spear.

15) A bale handling apparatus adapted for mounting to operating equipment, the apparatus comprising:
a frame or body onto that is mounted on, attached to or engaged with a mounting assembly adapted to engage with a complementary mounting assembly of operating equipment;
a first set of spears mounted on, attached to or engaged with the frame and comprising a single first main spear and one or more spaced away first stabilizer spears; and
a second set of spears mounted on, attached to or engaged with the frame and comprising a single second main spear and one or more spaced away second stabilizer spears; wherein
the first and second sets of spears are horizontally offset from each other;
the base of the first main spear is vertically offset from the base of the second main spear, with respect to the frame; and
the main spears are longer and/or larger in diameter than their respective stabilizer spears.

16) The apparatus of claim 15, wherein the mounting assembly is adapted for mounting the apparatus onto a three-point hitch.

17) The apparatus of claim 15, wherein the base of the first main spear is horizontally offset from the base of the second main spear by a distance that is less than or approximately equal to the average diameter, average length or average width of a bale that the apparatus is adapted to lift.

18) The apparatus of claim 15, wherein the base of the first main spear is horizontally offset from the base of the second main spear by a distance that is greater than the average diameter, average length or average width of a bale that the apparatus is adapted to lift.

19) The apparatus of claim 15, wherein the base of the first main spear is horizontally offset from the base of the second main spear by a distance that is at least about 75% of the average diameter, average length or average width of a bale that the apparatus is adapted to lift.

20) The apparatus of claim 15, wherein the base of the first main spear is vertically offset from the base of the second main spear by a distance that is at least about 5% of the average diameter, average length or average width of a bale that the apparatus is adapted to lift.

21) The apparatus of claim 15, wherein at least one stabilizer spear is spaced away from its respective main spear by a distance of at least about 25% to about 85% of the average diameter, average length or average width of a bale that the apparatus is adapted to lift.

22) The apparatus of claim 15, wherein at least one stabilizer spear is horizontally offset with respect to its respective main spear.

23) The apparatus of claim 15, wherein the mounting assembly comprises plural mounting brackets.

24) The apparatus of claim 15, wherein each set of spears comprises a single stabilizer spear.

25) A bale handling apparatus adapted for mounting to operating equipment, the apparatus comprising:
a frame or body onto that is mounted on, attached to or engaged with a mounting assembly adapted to engage with a complementary mounting assembly of operating equipment;
a first set of spears mounted on, attached to or engaged with the frame and comprising a single first main spear and one or more spaced away first stabilizer spears; and
a second set of spears mounted on, attached to or engaged with the frame and comprising a single second main spear and one or more spaced away second stabilizer spears; wherein
the first and second sets of spears are horizontally offset from each other;
the base of the first main spear is vertically offset from the base of the second main spear, with respect to the frame, by a distance that is at least about 5% of the average diameter, average length or average width of a bale that the apparatus is adapted to lift; and
the base of the first main spear is horizontally offset from the base of the second main spear by a distance that is at least about 75% of the average diameter, average length or average width of a bale that the apparatus is adapted to lift.
